(19) United States
(12) Patent Application Publication
(10) Pub. No.: US 2012/0285938 A1
(43) Pub. Date: Nov. 15, 2012

(54) FLUX CORED ARC WELDING SYSTEM WITH HIGH DEPOSITION RATE AND WELD WITH ROBUST IMPACT TOUGHNESS

(75) Inventors: Lisa McFadden, Cleveland, OH (US); Badri Narayanan, Cleveland Heights, OH (US); Sev Johansson, Cleveland Heights, OH (US)

(73) Assignee: LINCOLN GLOBAL, INC., City of Industry, CA (US)

(21) Appl. No.: 13/104,952

(22) Filed: May 10, 2011

(51) Int. Cl. B23K 9/10

(52) U.S. Cl. 219/130.1

(57) ABSTRACT

An arc welding system includes a wire feeding mechanism for delivering welding wire to a welding operation, and a welding power supply for generating a current for welding to the welding wire. The welding wire includes at least two distinct types of welding electrodes.

### TECHNICAL FIELD

The present disclosure relates to welding systems, and more specifically, to a flux cored arc welding system with a high deposition rate creating a weld with robust impact toughness.

### BACKGROUND

Welding is an important process in the manufacture and construction of various products and structures. Applications for welding are widespread and used throughout the world including, for example, the construction and repair of ships, buildings, bridges, vehicles, and pipe lines, to name a few. Welding is performed in a variety of locations, such as in a factory with a fixed welding operation or on site with a portable welder.

In automated or mechanized welding a user/operator (i.e. welder) programs or instructs welding equipment to make a weld. For example, in Submerged Arc Welding (SAW) a consumable solid or tubular (flux cored) electrode may be continuously fed into a molten weld or arc zone that is protected from atmospheric contamination by being “submerged” under flux such as a blanket of granular fusible material consisting of lime, silica, manganese oxide, calcium fluoride, or other suitable compounds. For example, this type of welding may be self-shielded or gas shielded. Generally, in either case, when molten, the flux becomes conductive, and provides a current path between the electrode and the work. A thick layer of flux completely covering the molten metal may thus prevent spatter and sparks as well as suppress the intense ultraviolet radiation and fumes that may be a part of the arc welding process. In such a process, currents ranging from 300 to 2000 A may be utilized. Additionally, currents of up to 5000 A may be used with multiple arcs. Single or multiple electrode wire variations of the process exist. Also, DC or AC power can be used, and/or combinations of DC and AC in multiple electrode systems. Generally, constant voltage welding power supplies are most commonly used; however, constant current systems in combination with a voltage sensing wire-feeder are also available.

In manual or semi-automated welding a user/operator (i.e. welder) directs welding equipment to make a weld. For example, in electric arc welding the welder may manually position a welding rod or welding wire and produce a heat generating arc at a weld location. In this type of welding, the spacing of the electrode from the weld location is related to the arc produced and to the achievement of optimum melting/fusing of the base and welding rod or wire metals. The quality of such a weld is often directly dependant upon the skill of the welder.

### SUMMARY OF THE INVENTION

This invention relates to welding systems with a high deposition rate creating a weld with high robust impact toughness.

In at least one embodiment, an arc welding system includes a wire feeding mechanism for delivering welding wire to a welding operation, and a welding power supply for generating a current for welding to the welding wire. The welding wire includes at least two distinct types of welding electrodes.

Various aspects will become apparent to those skilled in the art from the following detailed description and the accompanying drawings.

### BRIEF DESCRIPTION OF THE DRAWINGS

FIG. 1 is a schematic diagram of a welding system with twin wire delivery;

FIG. 2 is a schematic diagram of a welding system with single lead/single trail tandem wire delivery;

FIG. 3 is a schematic diagram of a welding system with single lead/twin trail wire delivery;

FIG. 4 is a schematic diagram of a welding system with twin lead/single trail wire delivery; and

FIG. 5 is a schematic diagram of a welding system with twin lead/twin trail wire delivery.

### DETAILED DESCRIPTION

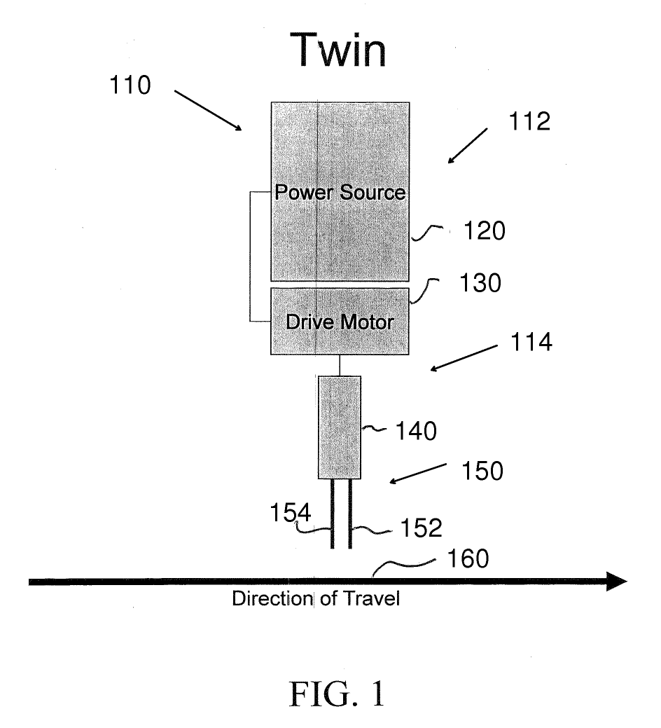

Referring now to the drawings, FIG. 1 illustrates an arc welding system 110 in accordance with one embodiment. The arc welding system 110 includes a welding power supply 112 and a wire feeding mechanism 114.

In the welding system 110, the welding power supply 112 includes a welding power source 120 and the wire feeding mechanism 114 includes a drive motor 130 and a twin wire feeder 140.

Driven by the drive motor 130, the twin wire feeder 140 delivers welding wire 150 to a welding operation on workpiece 160. The welding wire 150 includes a first welding electrode 152 and a second welding electrode 154. The workpiece 160 is illustrated as moving relative to the welding system 110. However, it must be understood that it may be either the welding system 110 or the workpiece 160 that is actually physically displaced. During the welding operation, the welding power supply 112 generates a current for welding to the welding wire 150. In the present example the welding power source 120 of the welding power supply 112 is the source of welding power for both of the first and second welding electrodes 152 and 154.

The first and second welding electrodes 152 and 154 are two distinct types of welding electrodes. In the present embodiment the first and second welding electrode 152 and 154 are both some type of flux cored electrode that differ in chemical composition or size or both.

In operation the arc welding system 110 delivers the two distinct types of welding electrode, e.g. the first and second welding electrodes 152 and 154 to a welding operation. The first and second welding electrodes 152 and 154 are delivered with twin wire delivered by the twin wire feeder 140. During the welding operation high deposition rates are achieved with the two distinct first and second flux cored electrodes 152 and 154 delivered to a twin arc welding process. By varying the composition and/or sizes of the first and second electrodes 152 and 154, x-ray quality welds with robust impact properties can be made, for example, with deposition rates greater than 15 lbs/hr.

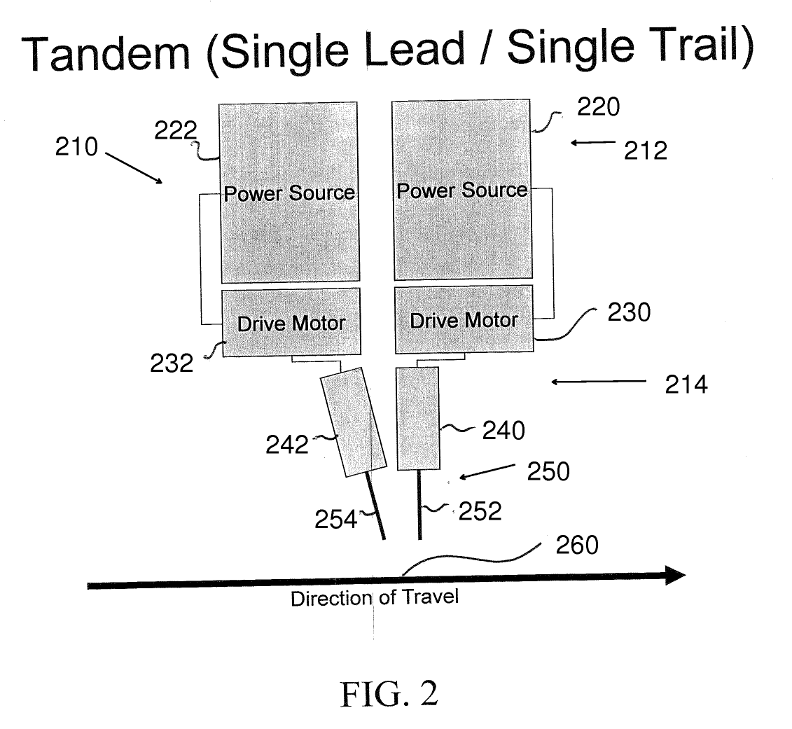

There is illustrated in FIG. 2, an arc welding system 210 in accordance with another embodiment. The arc welding system 210 includes a welding power supply 212 and a wire feeding mechanism 214.

In the welding system 210, the welding power supply 212 includes a first welding power source 220 and a second welding power source 222. The wire feeding mechanism 214 includes a first drive motor 230 and a second drive motor 232. The wire feeding mechanism 214 also includes a first wire feeder 240 and second wire feeder 242.

Driven by the drive motors 230 and 232, the tandem wire feeders 240 and 242 deliver welding wire 250 to a welding operation on workpiece 260. The welding wire 250 includes a first welding electrode 252 and a second welding electrode 254. The workpiece 260 is illustrated as moving relative to the welding system 210. However, it must be understood that it may be either the welding system 210 or the workpiece 260 that is actually physically displaced. During the welding operation, the welding power supply 212 generates a current for welding to the welding wire 250. In the present example the welding power sources 220 and 222 of the welding power supply 212 are the sources of welding power for each of the first and second welding electrodes 252 and 254 respectively.

The first and second welding electrodes 252 and 254 are two distinct types of welding electrodes. In the present embodiment the first and second welding electrode 252 and 254 are both some type of flux cored electrode that differ in chemical composition or size or both.

In operation the arc welding system 210 delivers the two distinct types of welding electrode, e.g. the first and second welding electrodes 252 and 254 to a welding operation. The first and second welding electrodes 252 and 254 are delivered with tandem wire delivered by the tandem wire feeders 240 and 242. During the welding operation high deposition rates are achieved with the two distinct first and second flux cored electrodes 252 and 254 delivered to a twin arc welding process. By varying the composition and/or sizes of the first and second electrodes 252 and 254, x-ray quality welds with robust impact properties can be made, for example, with deposition rates greater than 15 lbs/hr.

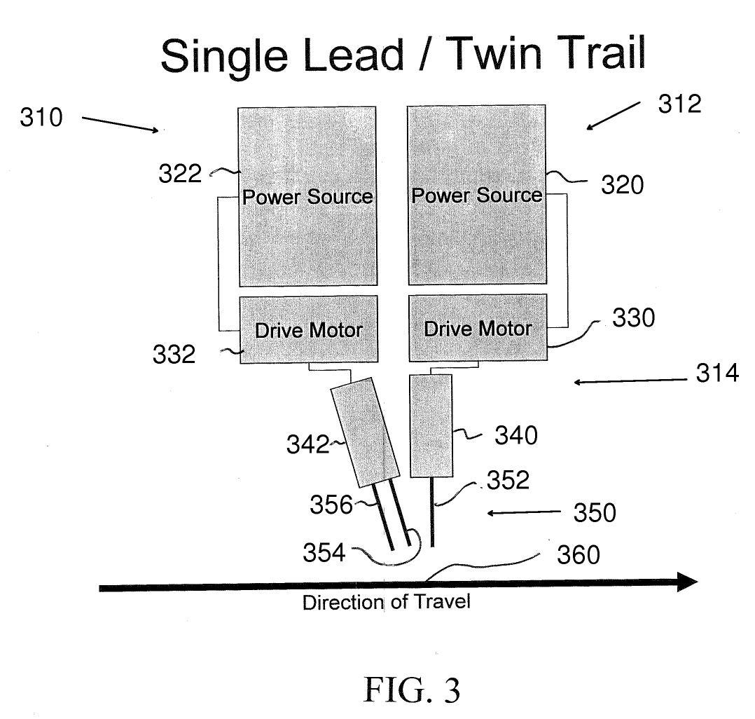

There is illustrated in FIG. 3, an arc welding system 310 in accordance with yet another embodiment. The arc welding system 310 is similar to the arc welding systems 110 and 210 of FIGS. 1 and 2, expect as described below. Similar components are identified with similar identifiers. The arc welding system 310 includes a tandem wire feeding mechanism 314, which includes a single lead wire feeder 340 and a twin trail wire feeder 342. Together the single lead wire feeder 340 and the twin trail wire feeder 342 deliver first, second and third welding electrodes 352, 354 and 356. At least one of the first, second and third welding electrodes 352, 354 and 356 is a different type of electrode than the other two. It must be understood that this may be the first electrode 352 or either of the second or third electrodes 354 and 354. Additionally, it must be understood that it is contemplate that all three of the first, second and third electrodes 352, 354 and 356 are of differing types.

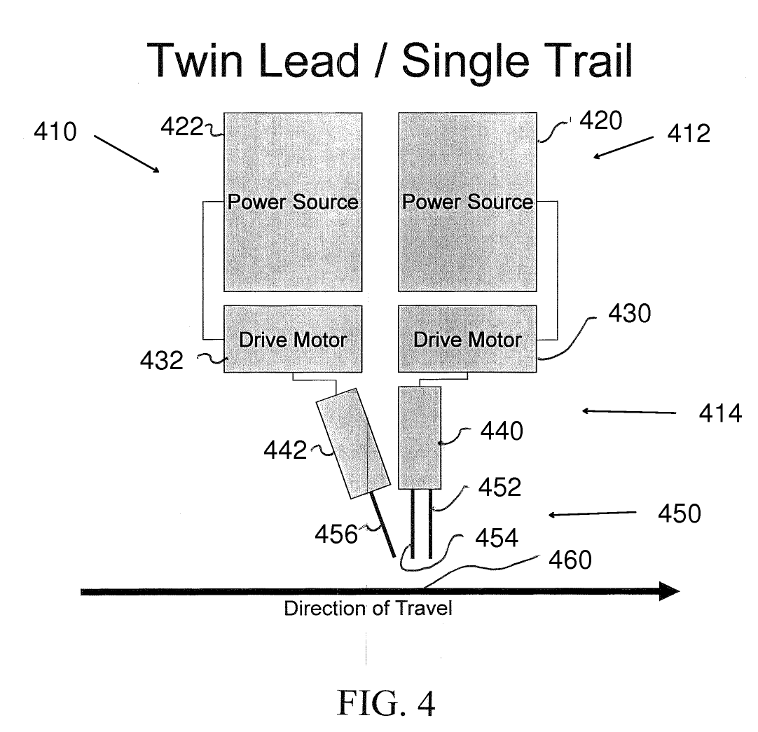

There is illustrated in FIG. 4, an arc welding system 410 in accordance with a further embodiment. The arc welding system 410 is similar to the arc welding system 310 of FIG. 3 expect as including a tandem wire feeding mechanism 414, which includes a twin lead wire feeder 440 and a single trail wire feeder 442. Similar components are identified with similar identifiers.

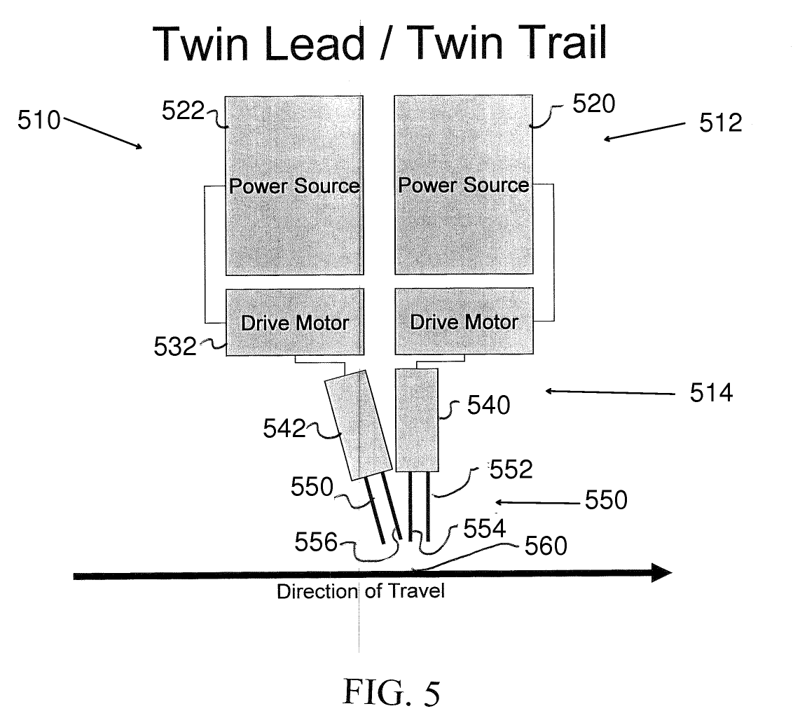

There is illustrated in FIG. 5, an arc welding system 510 in accordance with a yet further embodiment. The arc welding system 510 is similar to the arc welding systems 310 and 410 of FIGS. 3 and 4, expect as including a tandem wire feeding mechanism 514, which includes a twin lead wire feeder 540 and a twin trail wire feeder 542. Similar components are identified with similar identifiers. At least one of the first, second, third and fourth welding electrodes 552, 554, 556, and 558 is a different type of electrode than the other three. It must be understood it is contemplated that two of the electrodes may be of one type with the other two are of another type. It may be that the first and second electrodes 552 and 554 are of one type whole the third and fourth electrodes 556 and 558 are another, or, for further example the first and third electrodes 552 and 556 may be of one type with the second and fourth 554 and 558 are of another.

Thus, in at least one embodiment, high deposition rates are achieved with flux cored electrodes using a Tandem and/or Twin Arc welding process. It is contemplated that the use of at least two distinct types welding electrodes will enable a minimization of aluminum levels in the weld system, resulting in higher toughness, and higher productivity. It is further contemplated that by differing the composition and/or sizes of at least two electrodes, x-ray quality welds with robust impact properties can be made with deposition rates greater than 15 lbs/hr.

While principles and modes of operation have been explained and illustrated with regard to particular embodiments, it must be understood, however, that this may be practiced otherwise than as specifically explained and illustrated without departing from its spirit or scope.

What is claimed is:

1. An arc welding system comprising:
a wire feeding mechanism for delivering welding wire to a welding operation, and
a welding power supply for generating a current for welding to the welding wire,
wherein the welding wire includes at least two distinct types of welding electrodes.

2. The arc welding system of claim 1 where both of the at least the two types of welding electrodes are both some type of flux cored electrode.

3. The arc welding system of claim 1 where the at least the two types of welding electrodes are of different chemical composition.

4. The arc welding system of claim 1 where the at least the two types of welding electrodes are of different size.

5. The arc welding system of claim 1 where the wire feeding mechanism includes at least two drive motors.

6. The arc welding system of claim 1 where the welding power supply includes at least two power sources.

7. The arc welding system of claim 1 where the wire feeding mechanism includes a tandem wire feeder.

8. The arc welding system of claim 1 where the wire feeding mechanism includes a twin wire feeder.

9. A method of operating a welding system comprising:
(a.) providing an arc welding system including a wire feeding mechanism for delivering welding wire to a welding operation, and a welding power supply for generating a current for welding to the welding wire,
(b.) delivering at least two distinct types of welding electrodes with the wire feeding mechanism,
(c.) generating a welding current with the welding power supply for providing to the at least two distinct types of welding electrodes for welding, and
(d.) creating a weld on a work piece with the at least two distinct types of welding electrodes.

10. The method of claim 9 where the delivering of the at least two distinct types of welding electrodes results in a deposition rate greater than 15 lbs/hr.

11. The method of claim 9 where both of the at least the two types of welding electrodes are both some type of flux cored electrode.

12. The method claim 9 where the at least the two types of welding electrodes are of different chemical composition.

13. The method of claim 9 where the at least the two types of welding electrodes are of different size.

14. The method of claim 9 where the wire feeding mechanism includes at least two drive motors.

15. The method of claim 9 where the welding power supply includes at least two power sources.

16. The method of claim 9 where the wire feeding mechanism includes a tandem wire feeder.

17. The method of claim 9 where the wire feeding mechanism includes a twin wire feeder.

18. An arc welding system comprising:
a welding power supply for generating a current for welding to the welding wire, and
a means for delivering at least two distinct types of welding electrodes to a welding operation.

19. The arc welding system of claim 18 where both of the at least the two types of welding electrodes are both some type of flux cored electrode.

20. The arc welding system of claim 18 where the at least the two types of welding electrodes are of different chemical composition.

21. The arc welding system of claim 18 where the at least the two types of welding electrodes are of different size.

22. The arc welding system of claim 18 where the means for delivering delivers the at least two distinct types of welding electrodes to the welding operation in a tandem manner.

23. The arc welding system of claim 18 where the means for delivering delivers the at least two distinct types of welding electrodes to the welding operation in a twin manner.
